(19) United States
(12) Patent Application Publication
(10) Pub. No.: US 2006/0055960 A1
(43) Pub. Date: Mar. 16, 2006

(54) Image processing apparatus

(75) Inventors: Yoshiharu Hirano, Mishima-shi (JP); Hidenobu Suzuki, Numazu-shi (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Chiyoda-ku (JP)

(21) Appl. No.: 10/940,059

(22) Filed: Sep. 14, 2004

(51) Int. Cl. G06F 15/00

(52) U.S. Cl. 358/1.15

(57) ABSTRACT

An image processing apparatus which is connected to an external instrument via a network stores setting information of the image processing apparatus into a memory and transmits an electronic mail containing the setting information stored in the memory to an electronic mail address destination specified by the user when transmission of the setting information stored in the memory is requested.

### BACKGROUND OF THE INVENTION

1. Field of the Invention

This invention relates to an image processing apparatus and more particularly to an image processing apparatus such as a digital multi-function peripheral having a function of being connected to a network and making transmission/reception of data or the like with respect to an external instrument via the network.

2. Description of the Related Art

Conventionally, when an image processing apparatus such as a digital multi-function peripheral is connected to a network, a manager who manages the network is required to make the communication setting and operation setting with respect to the image processing apparatus by use of a host computer or the like. If an IP address or the like which is used to identify image processing apparatuses in the network is set in the host computer, conventionally, the manager himself checks the IP address or the like of the image processing apparatus and must manually input information such as the IP address to the host computer.

As the means for solving the above problem, conventionally, there is provided a method for searching for the image processing apparatuses connected to the network from the host computer side by use of a software provided by the maker of the image processing apparatus and acquiring an IP address.

However, with the above method, it is necessary to perform a search for the image processing apparatuses by use of the software provided by the maker of the image processing apparatus. Therefore, with the above method, it is impossible to search for image processing apparatuses of other makers which are connected to the network. Further, for example, when a plurality of image processing apparatuses of the same maker are connected to the same network, there occurs a problem that it becomes difficult to determine the installed location of an image processing apparatus which corresponds to a desired one of the IP addresses.

### BRIEF SUMMARY OF THE INVENTION

An object of this invention is to provide an image processing apparatus which can easily make settings for image processing apparatuses connected to a network and alleviate the trouble involved in the setting operation.

An image processing apparatus according to an aspect of this invention which is connected to an external instrument via a network, comprises a network interface for connection to the network, a memory which stores setting information of the image processing apparatus, an operation panel which specifies an electronic mail address as a transmission destination of the setting information of the image processing apparatus stored in the memory, and a processing section which forms an electronic mail containing the setting information of the image processing apparatus stored in the memory and transmits the electronic mail containing the setting information of the image processing apparatus to an electronic mail address destination specified by the operation panel.

A setting method of an image processing apparatus according to another aspect of this invention which is a setting method of an image processing apparatus connected to an external instrument via a network, comprises storing setting information of the image processing apparatus into a memory, forming an electronic mail containing the setting information of the image processing apparatus stored in the memory when an electronic mail address is specified as a transmission destination of the setting information of the image processing apparatus stored in the memory, and transmitting the thus formed electronic mail containing the setting information of the image processing apparatus to an electronic mail address destination specified.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view showing the schematic configuration of an image processing system containing digital multi-function peripherals as image processing apparatuses.

FIG. 2 is a block diagram schematically showing the configuration of a digital multi-function peripheral.

FIG. 3 is a view showing an example of the configuration of an operation panel.

FIG. 4 is a view showing an example of display on the operation panel when an electronic mail address is set.

FIG. 5 is a flowchart for illustrating an example of the operation of the digital multi-function peripheral connected to a network.

### DETAILED DESCRIPTION OF THE INVENTION

There will now be described an embodiment of this invention with reference to the accompanying drawings.

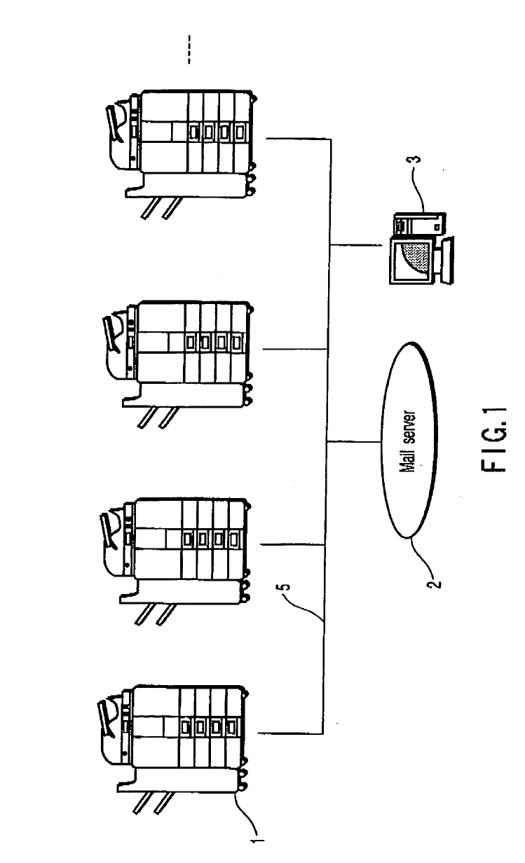

FIG. 1 is a view showing the schematic configuration of an image processing system containing digital multi-function peripherals as image processing apparatuses.

As shown in FIG. 1, in the image processing system, a plurality of digital multi-function peripherals (MFP) 1, mail server 2, host computer 3, user PCs (not shown) and the like are connected together via a network 5 such as a local area network.

The digital multi-function peripheral 1 mainly has a copy function, printer function, scanner function, network communication function and the like. The digital multi-function peripheral 1 holds various setting information items. For example, the digital multi-function peripheral 1 holds identification information containing an IP address to realize the network communication function as setting information. Thus, in the image processing system, the digital multi-function peripheral 1 is recognized by instruments on the network 5 by use of the identification information such as the IP address, for example.

Further, the digital multi-function peripheral 1 has a network scanner function, network printer function, electronic mail function and the like. The network scanner function is a function of transferring data of an image read by use of the scanner function to the instrument on the network 5 and is realized by use of the network communication function and scanner function. The network printer function is a function of printing image data from the instrument on the network 5 onto an image forming medium based on a print request from the instrument on the network 5 and is realized by use of the network communication function and printer function.

When an electronic mail is transmitted from the digital multi-function peripheral 1 to an external instrument (for example, host computer 3) on the network 5 by use of the electronic mail function, the digital multi-function peripheral 1 uploads the electronic mail to the mail server 2 via the network 5. As a result, the electronic mail can be transmitted from the digital multi-function peripheral 1 to the instrument on the network 5 based on the electronic mail function.

The mail server 2 is a server which has mail boxes of the respective instruments on the network 5 and manages transmission/reception of an electronic mail. The mail server 2 holds the uploaded electronic mails in the respective mail boxes and informs the respective instruments of the presence or absence of the electronic mail.

The host computer 3 is an external instrument (PC) which the manager of the network 5 uses. For example, the host computer 3 is configured by a main body having a network interface, display device, operating device and the like. The network interface of the host computer 3 realizes data communication with respect to the instruments on the network 5.

Next, the configuration of the digital multi-function peripheral 1 is explained.

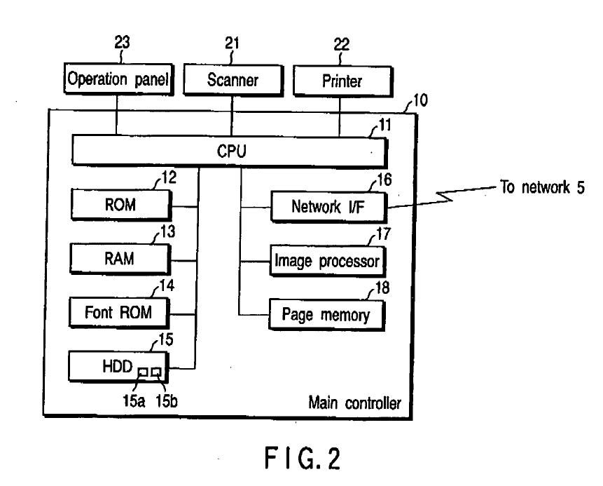

FIG. 2 is a block diagram schematically showing the configuration of the digital multi-function peripheral 1.

As shown in FIG. 2, the digital multi-function peripheral 1 is configured by a main controller 10, scanner 21, printer 22, operation panel 23 and the like. The main controller 10 controls the whole portion of the digital multi-function peripheral 1. The main controller 10 is configured by a CPU (Central Processing Unit) 11, ROM (Read Only Memory) 12, RAM (Random Access Memory) 13, font ROM 14, recording device (HDD) 15, network I/F 16, image processor 17, page memory 18 and the like.

The CPU 11 controls the whole portion of the digital multi-function peripheral 1. In the ROM 12, a software such as a control program to control the digital multi-function peripheral 1 is stored. In the RAM 13, data obtained during the operation is temporarily stored. In the font ROM 14, image data of characters corresponding to character codes is stored. For example, when print data of a character code is received from the external instrument, the CPU 11 converts the character code into corresponding image data based on font data stored in the font ROM 14.

The hard disk drive (HDD) 15 is a recording device of large capacity. The HDD 15 stores image data scanned by the scanner 21, image data to be printed by the printer 22, control software or various setting information items in the digital multi-function peripheral 1.

Further, the HDD 15 has a database 15a in which various setting information items are stored. In the database 15a, identification information such as an IF address of the digital multi-function peripheral 1 on the network or information indicating the configuration of the digital multi-function peripheral 1 is stored.

The HDD 15 further has an address book 15b of electronic mail addresses. In the address book 15b, the electronic mail addresses of the respective users who use the network 5 are stored. Further, in the address book 15b, information items indicating the rights to use the digital multi-function peripherals 1 of the respective users are stored in correspondence to the respective electronic mail addresses. For example, information indicating that the right to make settings with respect to the digital multi-function peripherals 1 in correspondence to the electronic mail addresses is given to the manager of the network 5 is stored.

The network interface 16 is an interface which makes data communication with respect to the instruments on the network 5. The image processor 17 is configured by an image processing circuit and the like and performs an image data correction process or data image compression/expansion process. The image memory 18 is a memory which stores image data of one page.

The CPU 11 is connected to the scanner 21, printer 22 and operation panel 23. The scanner 21 optically reads the image of a document and converts the thus read image into image data. The printer 22 prints an image on an image forming medium based on image data.

The operation panel 23 is configured by a display section which displays the operation guidance for the user and the operation setting state of the digital multi-function peripheral and an operating section to, which an operation instruction is input from the user. For example, the operation panel 23 is configured by a display device containing a touch panel, a hard key such as a numeric keypad and the like.

Next, an example of the configuration of the operation panel 23 is explained.

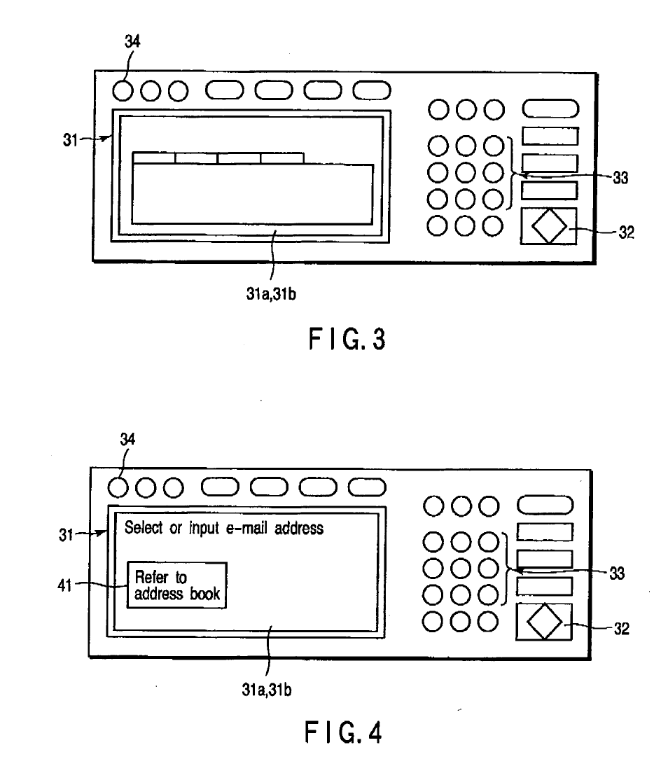

FIG. 3 is a view showing an example of the configuration of the operation panel 23.

The operation panel 23 shown in FIG. 3 includes a display device (display section 31a and touch panel 31b) 31 containing a touch panel, start button 32, numeric keypad 33 and information transmission button 34.

The display device 31 has a display section 31a which displays information. The display device 31 displays the number of documents and the number of copies as the display section 31a, displays the magnification of copy and edition and provides various types of operation guidance. Further, on the display section 31a of the display device 31, guidance for the selecting state of a paper feeding cassette and a jamming state of documents or paper sheets is displayed. On the display device 31, a touch panel functioning as the touch panel 31b is provided so as to permit various operation instructions to be input by use of various selection keys displayed on the display device 31.

The start button 32 is used to issue an instruction for starting the operation. For example, when the digital multi-function peripheral 1 is set in a copy mode, the start button 32 specifies a copy start. Further, when the digital multi-function peripheral 1 is set in a scan mode, the start button 32 specifies a scan start. As will be described later, when the digital multi-function peripheral 1 transmits an electronic mail, the start button 32 specifies a start of transmission of the electronic mail to the electronic mail address specified.

The numeric keypad 33 includes keys to input numerals and alphabets. For example, the number of documents and the number of copies are set by use of the numeric keypad 33. As will be described later, an electronic mail address is input by use of the numeric keypad 33. The information transmission button 34 is a key to specify that setting information of the digital multi-function peripheral 1 is transmitted to the instrument such as the host computer 3 on the network 5. The start button 32, numeric keypad 33 and information transmission button 34 can be realized by use of the touch panel 31b of the display device 31.

Next, the setting information of the electronic mail address by use of the operation panel 23 is explained.

FIG. 4 is a view showing an example of display on the operation panel when an electronic mail address is set. Further, FIG. 4 shows a display example of a case wherein the information transmission button 34 is specified.

That is, when the information transmission button 34 of the operation panel 23 is specified, selection guidance or input of an electronic mail address is displayed on the display device 31 as shown in FIG. 4. In this state, the user inputs an electronic mail address. For example, when the electronic mail address is directly input (specified) by use of alphanumeric characters, the user directly inputs the electronic mail address by use of the numeric keypad 33.

Further, when the electronic mail address is selected (specified) by referring to the address book 15b, the user specifies a reference key 41 of the address book 15b which can be selected by use of the touch panel 31b of the display device 31. In this case, a list of the electronic mail addresses stored in the address book 15b is displayed on the display device 31 in response to the specification of the reference key 41.

The electronic mail addresses displayed in a list form can be selected by use of the touch panel 31b, numeric keypad 33 or the like. As a result, the user can select a desired electronic mail address from the electronic mail addresses of the address book 15b displayed in a list form on the display device 31.

The electronic mail addresses displayed in the list form on the display section 31a can be selected by referring to the address book held in the mail server 2. In this case, the digital multi-function peripheral 1 accesses the mail server 2 when the reference key 41 is specified and acquires a corresponding electronic mail address from the mail server 2.

Next, the setting operation for the digital multi-function peripheral 1 connected to the network 5 is explained.

In this case, a case wherein a newly installed digital multi-function peripheral is used as the digital multi-function peripheral 1 and connected to the network 5 is assumed and the host computer 3 is assumed to make communication setting and operation setting for the digital multi-function peripheral 1.

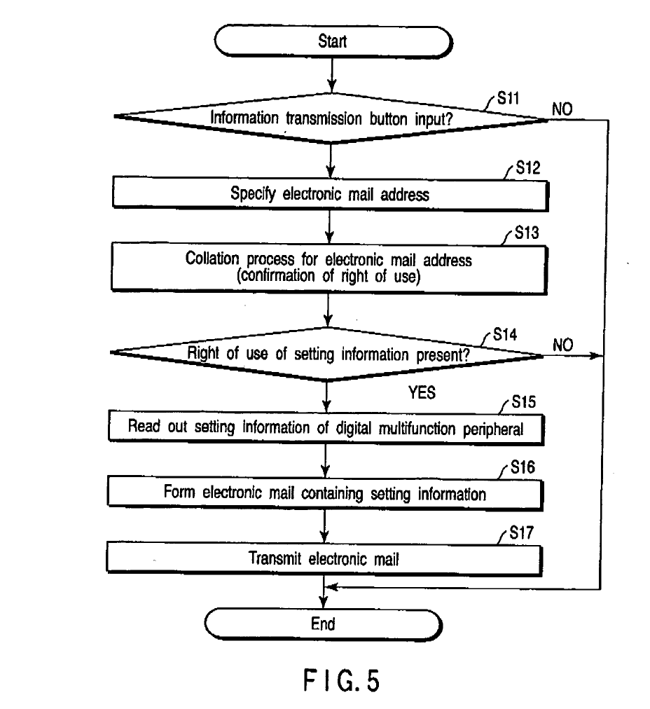

FIG. 5 is a flowchart for illustrating an example of the operation of the digital multi-function peripheral 1 connected to the network 5.

First, the user specifies the information transmission button 34 provided on the operation panel 23 of the digital multi-function peripheral 1. When the information transmission button 34 is specified (“YES” in the step S11), the CPU 11 of the main controller 10 displays a screen on which a request is made to specify an electronic mail address as shown in FIG. 4 on the display device 31 of the operation panel 23 (step S12).

The electronic mail address corresponds to a transmission destination to which the setting information of the digital multi-function peripheral 1 is transmitted. When setting for the digital multi-function peripheral 1 is made in the host computer 3, the electronic mail address of the manager who performs the setting operation in the host computer 3 is specified as the electronic mail address.

If the electronic mail address is specified by the user, the CPU 11 performs the collation process for the specified electronic mail address and the electronic mail addresses stored in the address book 15b of the HDD 15 (step 313). The collation process is performed to confirm the right of use relating to the user of the specified electronic mail address. Therefore, in the collation process, the specified electronic mail address is collated with the electronic mail addresses stored in the address book 15b.

If one of the electronic mail addresses which coincides with the specified electronic mail address lies in the address book 15b, the CPU 11 determines whether or not the user of the specified electronic mail address has a right to use the setting information of the digital multi-function peripheral 1 based on information indicating the right of use stored in the address book 1b in correspondence to the above electronic mail address (step S14).

If it is determined by the above determination process that the user of the specified electronic mail address has the right to use the setting information of the digital multi-function peripheral 1 (“YES” in the step S14), the CPU 11 reads out the setting information of the digital multi-function peripheral 1 from the database 15a of the HDD 15 (step S15).

In this case, as the setting information read out from the database 15a, information relating to the communication setting of the digital multi-function peripheral 1, information indicating the configuration of the digital multi-function peripheral 1, information relating to the operation setting of the digital multi-function peripheral 1 and the like are provided.

For example, as the information relating to the communication setting of the digital multi-function peripheral 1, information (identification information) which is used to identify the digital multi-function peripheral 1 on the network 5 is provided. The identification information used to identify the digital multi-function peripheral 1 on the network 5 contains an IP address, mask address, default gateway and the like, for example.

Further, as the information indicating the configuration of the digital multi-function peripheral 1, for example, information relating to optional instruments is provided. As the optional instruments connected to the digital multi-function peripheral 1, for example, a finisher which performs the process for sheets of printed paper and an automatic document feeder (ADF) which feeds and scans documents one by one are provided.

Further, as the information (operation setting information) relating to the operation setting of the digital multi-function peripheral 1, for example, information indicating the sizes of sheets of paper used as image forming media set in respective paper cassettes of the digital multi-function peripheral 1 is provided.

If the setting information of the digital multi-function peripheral 1 is read out from the database 15a, the CPU 11 forms an electronic mail containing the setting information of the digital multi-function peripheral 1 (step S16). At this time, a software which is used to perform the setting process in the host computer 3 based on the setting information of the digital multi-function peripheral 1 may be attached to the above electronic mail.

If the electronic mail containing the setting information of the digital multi-function peripheral 1 is formed, the CPU 11 uploads the electronic mail to the mail server 2 by use of an electronic mail address destination specified by the user (step S11). As a result, the digital multi-function peripheral 1 can transmit the electronic mail containing the setting information of the digital multi-function peripheral 1 to the electronic mail address destination specified by the user.

The host computer 3 receives the electronic mail containing the setting information of the digital multi-function peripheral 1 via the mail server 2. When the electronic mail is received, the host computer 3 performs various setting operations for the digital multi-function peripheral 1 with reference to the setting information of the digital multi-function peripheral 1 indicated by the electronic mail.

Thus, on the host computer 3 side, the communication setting for the digital multi-function peripheral 1, setting for the configuration of the digital multi-function peripheral 1, setting for the operation setting of the digital multi-function peripheral 1 can be easily and stably made.

Further, as described above, when the software which is used to perform the setting process in the host computer based on the setting information of the digital multi-function peripheral is attached to the electronic mail, the host computer 3 executes the software.

As a result, in the host computer 3, various settings for the digital multi-function peripheral 1 which reflect the setting information of the digital multi-function peripheral 1 can be easily and stably made.

As described above, according to the present embodiment, information necessary for setting of the digital multi-function peripheral is transmitted to the external instrument on the network by use of the electronic mail. Therefore, it becomes unnecessary to search for the digital multi-function peripheral which lies on the network from the external instrument. Further, the user can easily and stably acquire information of the digital multi-function peripheral which lies in a desired location. As a result, it becomes possible to alleviate the load of the setting operation of the digital multi-function peripheral in the instrument on the network.

In the above embodiment, a case wherein the setting information of the digital multi-function peripheral is transmitted from the digital multi-function peripheral side to the host computer side by use of the electronic mail is explained. Likewise, a driver software for the digital multi-function peripheral may be transmitted from the digital multi-function peripheral side to the host computer side by use of the electronic mail.

This can be attained by previously storing the driver software in the HDD 15 of the digital multi-function peripheral 1 and transmitting the driver software to an electronic mail address specified by the user. Therefore, it becomes unnecessary to provide a storage medium (CD-ROM or the like) which is used to install the driver software of the digital multi-function peripheral into the host computer. Thus, it becomes possible to efficiently install the driver software of the digital multi-function peripheral in the host computer.

The driver software of the digital multi-function peripheral has large data capacity in many cases. Therefore, the digital multi-function peripheral 1 can compress and attach the driver software to the electronic mail and transmit the same. As a result, the load on the network caused by data transferred from the digital multi-function peripheral 1 to the host computer 3 can be alleviated.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An image processing apparatus which is connected to an external instrument via a network, comprising:
a network interface for connection to the network,
a memory which stores setting information of the image processing apparatus,
an operation panel which specifies an electronic mail address as a transmission destination of the setting information of the image processing apparatus stored in the memory, and
a processing section which forms an electronic mail containing the setting information of the image processing apparatus stored in the memory and transmits the electronic mail containing the setting information of the image processing apparatus to an electronic mail address destination specified by the operation panel.

2. The image processing apparatus according to claim 1, wherein the setting information stored in the memory is identification information which is used to identify the image processing apparatus on the network connected thereto via the network interface.

3. The image processing apparatus according to claim 1, wherein the setting information stored in the memory is information which indicates the configuration of the image processing apparatus.

4. The image processing apparatus according to claim 1, wherein the setting information stored in the memory is information which indicates the state of operation setting of the image processing apparatus.

5. The image processing apparatus according to claim 1, wherein the operation panel includes a numeric keypad which inputs alphanumeric characters and an electronic mail address of a transmission destination is specified by use of the numeric keypad.

6. The image processing apparatus according to claim 1, wherein the memory further stores an address book by use of which electronic mail addresses of respective instruments on the network connected via the network interface are referred to, and the operation panel includes a reference key used to refer to the address book and displays a list of electronic mail addresses of the address book stored in the memory and selects and specifies an electronic mail of a transmission destination from the displayed list of electronic mail addresses when the reference key is specified.

7. The image processing apparatus according to claim 1, wherein the memory further stores a right of use for the image processing apparatus in correspondence to an electronic mail address of the user, and the processing section collates the electronic mail address specified by the operation panel with the electronic mail addresses stored in the memory when the electronic mail is specified by the operation panel and inhibits transmission of the electronic mail containing the setting information of the image processing apparatus to the electronic mail address destination specified by the operation panel when the right of use corresponding to one of the electronic mail addresses which is determined to coincide with the electronic mail specified by the operation panel in the collation process indicates inhibition of transmission of the setting information of the image processing apparatus.

8. A setting method of an image processing apparatus connected to an external instrument via a network, comprising:
storing setting information of the image processing apparatus into a memory,
forming an electronic mail containing the setting information of the image processing apparatus stored in the memory when an electronic mail address is specified as a transmission destination of the setting information of the image processing apparatus stored in the memory, and
transmitting the thus formed electronic mail containing the setting information of the image processing apparatus to an electronic mail address destination specified.

9. The setting method of the image processing apparatus according to claim 8, wherein the setting information stored in the memory is identification information which is used to identify the image processing apparatus on the network.

10. The setting method of the image processing apparatus according to claim 8, wherein the setting information stored in the memory is information indicating the configuration of the image processing apparatus.

11. The setting method of the image processing apparatus according to claim 8, wherein the setting information stored in the memory is information indicating the state of operation setting of the image processing apparatus.

12. The setting method of the image processing apparatus according to claim 8, further comprising:
storing an address book by use of which electronic mail addresses of instruments on the network are referred to into the memory,
displaying a list of electronic mail addresses of the address book stored in the memory on a display device when reference of the address book stored in the memory is specified, and
forming an electronic mail containing the setting information of the image processing apparatus stored in the memory when an electronic mail of a transmission destination is selected and specified from the list of electronic mail addresses displayed on the display device.

13. The setting method of the image processing apparatus according to claim 8, further comprising:
storing a right of use for the image processing apparatus into the memory in correspondence to an electronic mail address of the user,
collating the electronic mail address specified with the electronic mail addresses stored in the memory when the electronic mail is specified, and
inhibiting transmission of the electronic mail containing the setting information of the image processing apparatus to the specified electronic mail address destination when the right of use corresponding to one of the electronic mail addresses which is determined to coincide with the electronic mail specified in the collation process indicates inhibition of transmission of the setting information of the image processing apparatus.

14. A process comprising:
a multifunction peripheral creating an email, wherein the multifunction peripheral comprises a copier, a printer, a scanner, and a network interface, wherein the e-mail comprises setting information associated with the multifunction peripheral.

15. The process of claim 14, wherein the e-mail further comprises software for setting the multifunction peripheral.

16. The process of claim 14, wherein the e-mail anther comprises driver software associated with the multifunction peripheral.

17. The process of claim 14, wherein the setting information comprises communication setting information associated with the multifunction peripheral, configuration information associated with the multifunction peripheral and operation setting information associated with the multifunction peripheral.

18. The process of claim 14, further comprising:
the multifunction peripheral receiving an instruction to send the e-mail to an e-mail address
the multifunction peripheral storing information indicating a right to set the multifunction peripheral, the right associated with the e-mail address
the multifunction peripheral determining if the email may be sent to the e-mail address based on the right associated with the e-mail address
if the email may be sent to the e-mail address, the multifunction peripheral sending the e-mail to the e-mail address.

19. The process of claim 14, wherein
the e-mail anther comprises software for setting the multifunction peripheral and driver software associated with the multifunction peripheral
the setting information comprises communication setting information associated with the multifunction peripheral, configuration information associated with the multifunction peripheral and operation setting information associated with the multifunction peripheral.

20. The process of claim 19 further comprising:
the multifunction peripheral receiving an instruction to send the e-mail to an e-mail address
the multifunction peripheral storing information indicating a right to set the multifunction peripheral, the right associated with the e-mail address
the multifunction peripheral determining if the e-mail may be sent to the e-mail address based on the right associated with the e-mail address
if the e-mail may be sent to the e-mail address, the multifunction peripheral sending the e-mail to the e-mail address.

21. A multifunction peripheral comprising:
a copier
a printer
a scanner
a network interface
a processor
a memory coupled with the processor
a storage medium having instructions stored thereon which when executed cause the multifunction peripheral to perform actions comprising
creating an e-mail, wherein the e-mail comprises setting information associated with the multifunction peripheral.

22. The multifunction peripheral of claim 21, wherein the e-mail further comprises software for setting the multifunction peripheral.

23. The multifunction peripheral of claim 21, wherein the e-mail further comprises driver software associated with the multifunction peripheral.

24. The multifunction peripheral of claim 21, wherein the setting information comprises communication setting information associated with the multifunction peripheral, configuration information associated with the multifunction peripheral and operation setting information associated with the multifunction peripheral.

25. The multifunction peripheral of claim 21, wherein the storage medium has instructions stored thereon which when executed cause the multifunction peripheral to perform actions further comprising:
receiving an instruction to send the e-mail to an e-mail address
storing information indicating a right to set the multifunction peripheral, the right associated with the e-mail address
determining if the e-mail may be sent to the e-mail address based on the right associated with the e-mail address
if the e-mail may be sent to the e-mail address, the multifunction peripheral sending the e-mail to the e-mail address.

26. The multifunction peripheral of claim 21, wherein
the e-mail further comprises software for setting the multifunction peripheral and driver software associated with the multifunction peripheral
the setting information comprises communication setting information associated with the multifunction peripheral, configuration information associated with the multifunction peripheral and operation setting information associated with the multifunction peripheral.

27. The multifunction peripheral of claim 26, wherein the storage medium has instructions stored thereon which when executed cause the multifunction peripheral to perform actions further comprising:
receiving an instruction to send the e-mail to an e-mail address
storing information indicating a right to set the multifunction peripheral, the right associated with the e-mail address
determining if the email may be sent to the e-mail address based on the right associated with the e-mail address
if the e-mail may be sent to the e-mail address, the multifunction peripheral sending the e-mail to the e-mail address.
